(19) United States
(12) Patent Application Publication
(10) Pub. No.: US 2020/0199696 A1
(43) Pub. Date: Jun. 25, 2020

(54) FOAMY SLAG CONDITIONER COMPOUND

(71) Applicant: Hickman, Williams & Company, Cincinnati, OH (US)

(72) Inventor: John F. Jennings, Seymour, IN (US)

(73) Assignee: Hickman, Williams & Company, Cincinnati, OH (US)

(21) Appl. No.: 16/665,486

(22) Filed: Oct. 28, 2019

Related U.S. Application Data
(60) Provisional application No. 62/783,329, filed on Dec. 21, 2018.

(51) Int. Cl. C21B 11/10; F27B 3/10; C21B 3/02; F27B 3/08

(52) U.S. Cl. CPC C21B 11/10; F27B 3/105; C21B 2400/05; F27B 3/085; C21B 3/02

(57) ABSTRACT

A compound for forming a foamy slag layer for use in an electric arc furnace, is described. The electric arc furnace has a chamber for melting scrap steel and an opening for introducing material into the chamber. The compound has un-calcined dolomite ore having a weight percentage from about 10% to about 60% and carbon having a weight percentage from about 40% to about 90%. The un-caicined dolomite ore and carbon are introduced to the chamber of the electric arc furnace while the scrap steel is being melted to form a foamy slag layer on the surface of the molten steel.

### CROSS-REFERENCE

The present patent application is based upon and claims the benefit of provisional patent No. 62/783,329, filed Dec. 21. 2018.

### BACKGROUND OF THE INVENTION

The invention is directed to a conditioner compound that is used to form a foamy slag layer on the top of molten steel in an electric arc furnace (EAF). The invention utilizes an un-calcined dolomite ere material in combination with carbon to form the foamy slag layer.

When melting steel in an electric arc furnace at least one electrode is positioned in scrap steel contained in the furnace. Electrical power is provided to the electrode to heat up the scrap steel to a point where the scrap steel becomes molten. During the melting of the scrap steel it is desirable to have an insulating layer of slag positioned over the melting scrap steel to retain the heat from the electrode in the scrap steel and to prevent arc flare from the electrodes to the refractory walls. A foamy slag is desirable because it has a density that is less than the density of the molten steel and will, therefore, remain on top of the molten steel and function to keep the heat in the molten steel. The molten steel in the EAF can be acidic and can attack the refractory material that is in the melting chamber of the EAF. Prior foamy slag layers have been difficult to maintain in a foamed condition and this has limited such slag layers effectiveness as a thermal barrier. In addition, the composition of the prior foamy slag layers did not effectively control the acidic nature of the molten steel and this resulted in damage to the refractory material in the melting chamber of the EAF. The present invention is designed to overcome the deficiencies of the foamy slag layers previously used in electric arc furnaces.

### SUMMARY OF THE INVENTION

A conditioner compound for forming a foamy slag layer for use in an electric arc furnace, is described. The electric arc furnace has a chamber for melting scrap steel and an opening for introducing material into the chamber. The compound has un-calcined dolomite ore having a weight percentage from about 10% to about 60% and a carbon component having a weight percentage from about 40% to about 90%. The un-calcined dolomite ore and carbon are introduced to the chamber of the electric arc furnace while the scrap steel is being melted to form a foamy slag layer on the surface of the molten steel.

### DESCRIPTION OF THE DRAWINGS

FIG. 1 is a cross sectional view of an electric arc furnace showing the foamy slag compound of the present invention.

FIG. 2 is a cross sectional view of a melting chamber of an electric arc furnace.

FIG. 3 is a partial cross-sectional view of the refractory material of the melting chamber of an electric arc furnace.

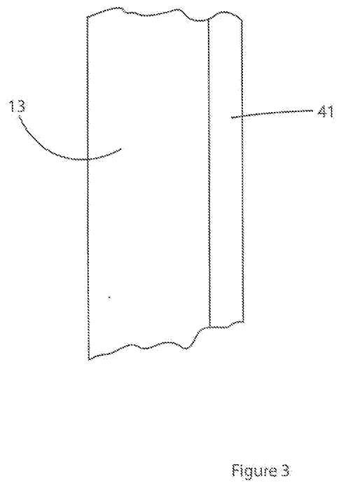

### DETAILED DESCRIPTION OF THE INVENTION

The invention is directed to a conditioner compound that is used to form a foamy slag layer on top of the molten steel in an electric arc furnace (EAF). More particularly, the invention utilizes an un-calcined dolomite ore material in combination with carbon to form the foamy slag layer. The details of the invention will be more readily understood by referring to the attached drawings in connection with the following description.

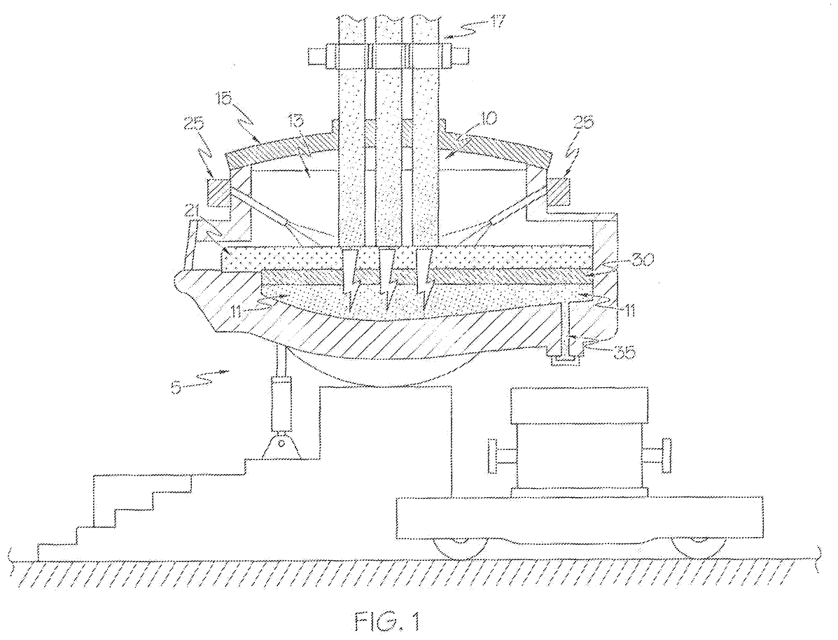

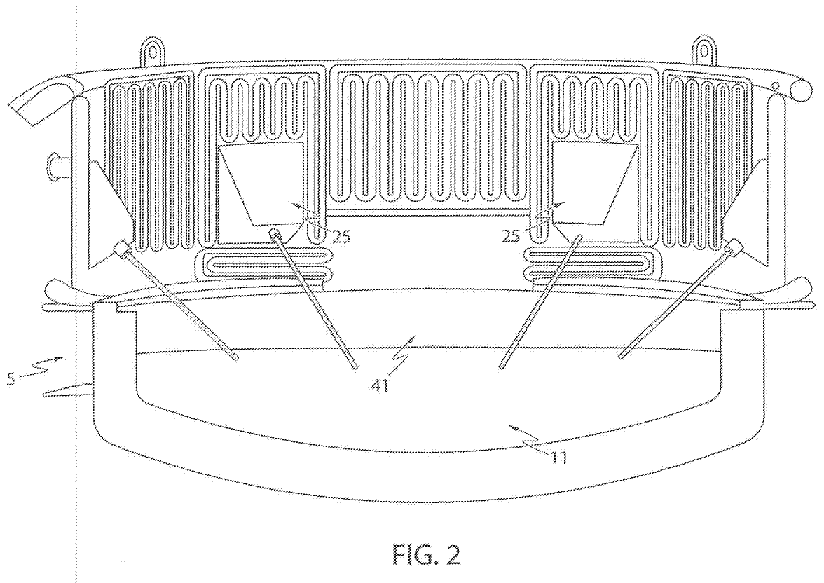

The compound of the present invention, as shown in figures 1 and 2, is used in an electric arc furnace 5. The EAF has a chamber 10 where scrap steel, calcined time, and calcined dololime 11 are deposited. The calcined lime and dololime materials are flux additives that lower the melting point of the molten slag and provide additives that assist in the refining of the steel. These flux components do, however, add to the cost of the steel refining process due to volume of these fluxes that are added. The calcined lime and calcined dololime are added to enhance the melting of the scrap steel as is known in the steel making industry. The chamber is lined with a refractory material 13 that can withstand the heat generated in the EAF. A roof 15 is positioned over the chamber 10 and forms an enclosed space where the scrap steel can be melted. At least one electrode 17 extends through the roof 15 into the chamber 10 and is in operative engagement with the scrap steel. In practice usually one or three electrodes are used to melt the scrap steel. The electrodes are operatively connected to a source of electrical power. The electrodes supply a substantial portion of the energy that is necessary to heat the scrap steel to a temperature where the scrap steel becomes molten. The basic EAF steel making process is known in the art and only details necessary to explain the advantages of the invention will be explained in detail.

During the melting process for the scrap steel it is desirable to retain the heat produced by the electrodes 17 in the molten steel. It is also desirable to prevent the electrodes from creating unstable arcs with the molten steel that reduce the heat transfer from the electrodes to the molten steel. Arcing between the electrodes and the steel can also contact the refractory material 13 and cause damage to the refractory material. To retain the heat from the electrodes in the steel 11 and to prevent arc flaring between the electrodes 17 and the refractory, a foamy slag layer 21 is positioned on top of the molten steel.

The EAF 5 has at least one port 25 located in the chamber 10. The port 25 is disposed to allow material to be introduced into the chamber on top of the scrap steel that is deposited in the chamber to be melted. Accordingly, the port is located in the chamber at a point that is above the level of scrap steel positioned in the chamber. Once the scrap steel is deposited in the chamber, electrical energy is supplied to the electrodes 17 to start the process of melting the scrap steel. Once the melting process has reached the desired level, a conditioner compound can be introduced through the at least one port 25 to create a foamy slag layer 21 on top of the steel that is being melted. A layer of liquid slag 30 is formed on the top of the molten steel. The liquid slag layer is formed from impurities in the scrap steel that float to the surface of the molten steel during the melting process. The foamy slag layer is formed on top of the liquid slag layer and provides a layer of insulation that retains heat from the electrodes 17 in the molten steel 11 to increase the efficiency of the melting of the scrap steel. The foamy slag layer also functions as an insulator to significantly reduce arcing between the electrodes 17 and the refractory 13. The reduction in the arcing between the electrodes and the steel reduces the possibility that electrical arcs will contact the refractory material 13 of the chamber 10 and damage the refractory material.

The foamy slag layer is usually introduced and formed once ⅔ to ¾ of the scrap steel 11 in the chamber 10 is in a molten state. It is also possible to determine a power level for the electrodes that defines a level of melting of the scrap steel and use the power level as an indicator of when to form the foamy slag layer.

The conditioner compound of the present invention used to form the foamy slag layer is a mixture of carbon and un-calcined dolomite ore that is injected into the chamber 10 on top of the molten steel through one or more ports 25. The conditioner compound is usually particles that are sized to be easily injected onto the liquid slag layer that is on top of the molten steel. The size of the particles is determined by the size of the openings in a mesh or screen through which the particles pass through and are sized. The size of the mesh used for the carbon particles can be from about 4 to 100 with a preferred range from about 6 to about 50. For the dolomite ore, the mesh size is from about 4 to about 100, with a preferred range of from about 10 to about 40. The size of the mesh openings are based on U.S. mesh standard sizes. The conditioner compound can also be introduced as a carbon component and an un-calcined dolomite ore component that are introduced separately into the chamber 10. The separate components can be introduced through separate ports spaced around the chamber or through the same port or ports located around the chamber. In practice, it has been found to be preferable to introduce the conditioner compound as a mixture of carbon and un-calcined dolomite ore and to introduce this mixture through several ports 25 located around the chamber where the scrap steel is being melted. In practice, it has been found that from about 5 pounds to about 30 pounds and preferably from about 10 pounds to about 20 pounds of the foamy slag forming conditioner compound will be required for each ton of scrap steel that is melted in the EAF.

The conditioner compound that is introduced through the at least one port 25 is a combination of un-calcined dolomite ore and carbon. The dolomite ore comprises from about 10% to about 60% weight percent of the conditioner compound and the carbon comprises from about 40% to about 90% weight percent of the conditioner compound. In practice, it has been found to be preferable for the un-caicine dolomite ore to have a weight percentage of from about 15% to about 30%. The carbon in the conditioner compound is provided by petroleum coke, anthracite coal, graphite, metallurgical coke and other suitable sources of carbon, and mixtures or blends of these materials. The un-calcined dolomite ore has a weight percentage of CaCO₃ from about 45% to about 65% and a weight percentage of MgCO₃ from about 35% to about 55%. The un-calcined dolomite ore can also have a small weight percent of other components. It is important that the conditioner compound have less than 2% by weight of moisture so that the compound ss dry enough to easily flow and be capable of being injected into the furnace. Usually, the conditioner compound has a weight percentage of moisture from about 0.1% to about 0.9% to function the best with the molten steel. The dolomite ore can be dried if necessary, to reduce the moisture level to the desired level. Drying of the dolomite ore removes mostly surface moisture that allows the ore to flow arid be easily injected into the furnace. The dolomite ore is dried between about 250 to about 400 degrees Fahrenheit for a relatively short period of time. The carbon particles can also be dried, if necessary, to achieve the desired moisture content for the compound. The drying of the dolomite ore and/or carbon particle Is done under different conditions than the calcined products that have previously been used to make a foamy slag producing compound. The calcined process takes place at around 1,700 degrees Fahrenheit and for around three hours. The calcined process removes moisture and changes the characteristic or properties of the material that are calcined. A material that is calcined is heated above the thermal decomposition temperature or the transition temperature of the material for a sufficient time to change the material into something else. Calcination of a material results in disassociation of the material into simpler substances. This is not what is accomplished by the drying utilized in the present invention where primarily surface moisture is removed from the material. In addition, the calcined process requires the use of substantial energy over a long period, and this is very costly The components of the current condition compound do not require this extensive and costly calcination process.

The conditioner compound has a density that is lower than the density of the molten steel 11 and the liquid slag layer in the chamber 10. Accordingly, the conditioner compound stays on top of the molten steel and mixes with the slag layer. As the conditioner compound melts to become foamy, it reacts with the liquid slag layer and the molten steel. In particular, the carbon reacts with the iron oxide in the molten steel and produces cartoon monoxide (CO) gas. The CO gas is trapped in the layer of the conditioner compound that forms the foamy slag layer 21 on the top of the molten steel. The CO gas helps to create the foamy consistency for tots layer. In most melting applications in an EAF, oxygen is also introduced into the molten steel and the oxygen reacts with the molten steel to produce CO gas that bubbles into the foamy slag layer 21 and adds to the formation of foam for this layer. The dolomite ore in the conditioner compound contains primarily magnesium carbonate and calcium carbonate in the percentages as previously identified. The formula for this portion of the conditioner compound is CaMg (CO₃)₂. When heat from the EAF is added to the calcium and magnesium carbonates, calcination takes place and the compound undergoes a chemical reaction to CaO+MgO+2CO₂. That results in the dolomite ore undergoing a chemical reaction and changing to calcium and magnesium oxide along with the creation of a significant amount of carbon dioxide. In fact, from about 40% to about 60% by weight of the dolomite ore is converted to carbon dioxide when the heat from the EAF engages the conditioner compound. The carbon dioxide gas from the dolomite ore in the conditioner compound produces a significant quantity of bubbles that help to create a foamy slag layer from the conditioner compound. The CO₂ gas that is produced from the dolomite ore component of the conditioner compound produces smaller bubbles which act to produce a creamy foamy slag layer that has enhanced characteristics. The smaller bubbles of CO₂ gas have a larger surface area and retain the bubble shape longer than larger diameter gas bubbles. This results in a better foamy slag that remains foamy for a longer period of time. The reaction of the dolomite ore, when exposed to heat in the EAF, is an endothermic reaction that lowers the temperature of the foamy slag layer. Lowering the temperature of the foamy slag layer allows the foamy slag layer to remain in the foamy state longer and improves the performance of the foamy slag layer. If the EAF is too hot, the foamy slag layer may start to liquify and loose its foamy characteristic. If the temperature in the EAF is too low, a sufficient level of gas will not be generated to make the compound foam at a sufficient level. Having a foamy slag that has smaller bubbles and stays in a foamy condition longer, improves the stickiness of the foamy slag and results in a better coating on the refractory material of the furnace.

Once the molten steel has been processed to the desired level, the molten steel is removed from the chamber through discharge port 35 in the bottom of the chamber 10. The foamy slag layer 21 remains on the top of the molten steel as the density of the foamy slag is lower than the density of toe molten steel. All of the molten steel is not removed as a portion of the molten steel is left in the chamber to act as a starting point for the next batch of scrap steel that is to be melted in the EAF 5. As the molten steel is removed from the EAF, the foamy slag layer 21 moves lower in the chamber and contacts the refractory material 13 that lines the chamber 10. The foamy slag layer leaves a residual coating 41 on the refractory material. The molten steel in the chamber 10 can be acidic and attack the refractory material. The foamy slag layer contains magnesium and the magnesium content in the coating on the refractory helps to reduce the impact that the molten steel has on the refractory. The coating of foamy slag material on the refractory material is thicker as the additional CO₂ gas produced by the calcined dolomite ore component results in a foamy slag layer has a height that is larger than prior art foamy slags. It is believed that the calcium oxide that is present in the foamy slag also increases the thickness and stickiness of the foamy slag layer so that there is better adhesion with the refractory bricks that form the walls of the EAF. Also, as the foamy slag layer 30 is thicker or higher dimensionally than previously seen, there is more foamy slag available to coat the refractory material in the EAF. The foamy slag layer needs to be thick so that it coats the refractory but not so thick that it does not stick to the refractory. The coating of the foamy slag material on the refractory material is from about 30% to about 50% thicker, after each heat or batch of steel has been processed, than the coating produced by prior foamy slag conditioners. Visual inspections of the refractory material after the molten steel has been removed, shows that the joints between the refractory bricks are considerably less noticeable when the refractory is coated with the foamy slag of the present invention. With the current foamy slag materials, it takes from about 40% to about 60% fewer heats of the furnace to produce an acceptable coating on the refractory material of a new or rebuilt furnace. The thicker coating provided by the current foamy slag additive creates a better coating on the refractory material each time the furnace produces a new batch of steel. The improved coating on the refractory material greatly enchases the life of the refractory material and reduces the cost of furnace repairs and rebuilds. Foamy slags also have a V ratio (Viscosity Ratio) that helps to define the characteristics of the foamy slag. The V ratio is determined by dividing the sum of the basic components of the foamy slag by the sum of the acidic components of the foamy slag. The foamy slag of the present invention has a V ratio from about 1.2 to about 1.8, which is lower than previously thought to be acceptable. This reduction in the V ratio allows for flux additives, such as calcined lime and dolomite, to be removed from the original addition with the scrap steel in the furnace to have the proper balance of components to produce the desired type of steel. The removal of the flux additives significantly reduces the cost of refining the steel. The portion of the foamy slag layer 21 that does not coat the refractory material remains in the EAF.

The foamy slag forming compound defined herein results in a foamy slag that is easier to form and maintain on the top of the liquid slag on the molten steel. The foamy slag produced has improved characteristics that allow the foamy slag to foam effectively, retain the heat in the molten steel, and to prevent unbalanced arcing between the steel and the refractory. The thicker foamy slag of the current invention covers the arcing between the steel and the electrodes that function to melt the steel. By covering this arcing, the foamy slag reduces or eliminates undesirable, unbalanced arcing between the steel and the refractory material. The insulation and anti-arcing properties help to reduce the energy cost necessary to melt the scrap steel. The components of the foamy slag compound also reduce the amount of calcined dolomitic lime and calcined limestone flux material, that are placed in the EAF with the scrap steel or injected through ports 25 at the beginning of the melting process. Reducing the amount of calcined dolomite lime and calcined limestone is a significant cost savings in the refining of steel using an EAF. In early testing, it has been found that adding 1 lb. of the conditioner compound of this invention to form a foamy slag layer allows for from about 2 lbs. to about 6 lbs. of flux material to be removed from the EAF charge materials. This is a significant cost saving in materials used in the refining of the steel and is a significant advantage over the performance of prior foamy slag compounds used in EAF steel refining. The foamy slag compound also coats the refractory material in the EAF and reduces the deterioration of the refractory material by contact with the acidic molten steel in the EAF. The protection provided by this coating action of the foamy slag compound extends the life of the refectory material which is also a significant cost savings. In early testing, it has been found that the coating of the refractory achieved with the foamy slag layer 31 produced by the conditioner compound of this invention has resulted in from about 250 to about 750 additional heat cycles before it is necessary to repair or rebuild the refractory material in the EAF. This is an increase of refractory life from about 10% to about 40% and a reduction of the need to use gunning material to repair the refractory from about 10% to about 40%. Again, this is a significant improvement over the performance of prior foamy slag products. The reduction of arcing between the electrodes of the EAF and the steel toat is being melted improves the life of the electrodes which also reduces the cost of refining steel in an EAF. It has also been found that this mixture helps with the desulfurization late in the heat. The improved thermal characteristics of the foamy slag conditioner of this invention also reduces the time the furnace is using power to melt the components from about 1% to about 10%. This is an additional cost savings for producing steel.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A slag conditioner compound for forming a foamy slag layer for use in an electric arc furnace for making steel, the electric arc furnace having a chamber for melting scrap steel and an opening for introducing material into the chamber comprising.
an un-calcined dolomite ore having a weight percentage from about 10% to about 60%; and
carbon having a weight percentage from about 40% to about 90%. the un-calcined dolomite ore and carbon being introduced to the chamber while the scrap steel is being melted to form a foamy slag on the surface of the molten steel.

2. The compound of claim 1 wherein the carbon is selected from the group comprising petroleum coke, graphite, and anthracite coal, metallurgical coke and mixtures or blends of these materials.

3. The compound of claim 2 wherein the un-calcined dolomite ore and the carbon are mixed together and supplied to the chamber of the electric arc furnace as a single mixture.

4. The compound of claim 2 wherein the un-calcined dolomite ore and the carbon are supplied to the chamber of the electric arc furnace separately.

5. The compound of claim 1 wherein the un-calcined dolomite ore has a weight percent of CaCO₃ from about 45% to about 65% and a weight percent of MgCO₃ from about 35% to about 55%.

6. The compound of claim 1 wherein the un-caicined dolomite ore has a weight percentage from about 15% to about 30%.

7. The compound of claim 1 wherein the compound has a moisture content of iess than 2% by weight.
